(19) United States
(12) Patent Application Publication
(10) Pub. No.: US 2016/0154330 A1
(43) Pub. Date: Jun. 2, 2016

(54) IMAGE FORMING SHEET FOR ELECTROPHOTOGRAPHY

(71) Applicant: FUJI XEROX CO., LTD., Tokyo (JP)

(72) Inventors: Tomoo KOBAYASHI, Kanagawa (JP); Kojiro TSUTSUMI, Kanagawa (JP); Kaoru TORIKOSHI, Kanagawa (JP); Toshiyasu YUKAWA, Kanagawa (JP); Katsumi HARADA, Kanagawa (JP)

(21) Appl. No.: 14/723,052

(22) Filed: May 27, 2015

(30) Foreign Application Priority Data
Nov. 28, 2014 (JP) 2014-242413

(51) Int. Cl. G03G 7/00

(52) U.S. Cl. CPC G03G 7/004; G03G 7/0013; G03G 7/008

(57) ABSTRACT

Provided is an image forming sheet for electrophotography, in which the generation of blister is suppressed. The image forming sheet for electrophotography includes a substrate 110 and an image receiving layer having a pigment 122 coated on the substrate, particles 124 interspersed among the pigments 122, and a binding resin, a volume average particle diameter of the particles being larger than a thickness of a portion of the image receiving layer where the particles do not exist.

### CROSS-REFERENCE TO RELATED APPLICATIONS

This application is based on and claims priority under 35 USC 119 from Japanese Patent Application No. 2014-242413 filed on Nov. 28, 2014.

### BACKGROUND

1. Field

The present invention relates to an image forming sheet for electrophotography.

2. Description of the Related Art

In image formation (printing) by the electrophotographic system, a method of charging a surface of an image holding member, exposing the surface of the image holding member in response to an image signal to form an electrostatic latent image by a potential difference between exposed portions and unexposed portions, and then electrostatically developing the latent image with a color powder (image forming material) called a toner that has a polarity opposite to (or the same as) the potential of charging, thereby forming a visible image (toner image) on the surface of the image holding member. In the cases where a color image is to be formed, either this process is repeated several times, or plural image forming devices are arranged side-by-side to form color visible images, and these color visible images are transferred and fixed to an image recording member (immobilization: melting the color powder mainly by heat and solidifying the color powder by cooling).

### SUMMARY

<1> An image forming sheet for electrophotography, containing:

a substrate; and

an image receiving layer having a pigment coated on the substrate, particles interspersed among the pigment, and a binding resin;

wherein a volume average particle diameter of the particles is larger than a thickness of a portion of the image receiving layer where the particles do not exist.

### BRIEF DESCRIPTION OF DRAWINGS

FIG. 1 is a cross-sectional view showing an example of an image forming sheet according to an exemplary embodiment of the present invention.

FIG. 2 is an enlarged view of an image receiving layer in the image forming sheet shown in FIG. 1.

FIG. 3 is a cross-sectional view showing another example of an image forming sheet according to an exemplary embodiment of the present invention.

FIG. 4 is a cross-sectional view showing still another example of an image forming sheet according to an exemplary embodiment of the present invention.

In FIGs, 110 denotes Substrate, 120 denotes Image receiving layer, 122 denotes Pigment, 124 denotes Particle, 130 denotes Back layer, 140 denotes Adhesive layer.

### DETAILED DESCRIPTION

An exemplary embodiment of the present invention is hereunder described in detail.

### <Image Forming Sheet>

The image forming sheet for electrophotography (hereinafter also referred to simply as “image forming sheet”) according to the exemplary embodiment of the present invention has at least a substrate and an image receiving layer. The image receiving layer has a pigment coated on the substrate, particles interspersed among the pigments, and a binding resin, a volume average particle diameter of the particles being larger than a thickness of a portion of the image receiving layer where the particles do not exist.

In the image forming sheet, the image receiving layer is an outermost surface layer, and an image with a toner is formed on this image receiving layer by the electrophotographic system.

Conventionally, in the electrophotographic system, a toner (image forming material) is subjected to electrostatic development to form a toner image, this toner image is transferred onto an image forming sheet, and subsequently, the toner image on the image forming sheet is fixed upon heating and pressurization, thereby forming an image. However, there may be the case where air is contained in the toner image formed on the image forming sheet, and this air is swollen by heating at the time of fixing, whereby the swollen portion possibly becomes an image defect. This phenomenon is called blister. In particular, the blister is a phenomenon remarkably generated in the case of forming a multicolor image in which plural toner images are laminated on the image forming sheet.

On the other hand, in accordance with the image forming sheet according to the exemplary embodiment of the present invention, the generation of blister is suppressed as compared with the case where there is no escape space of air at all in the image receiving layer.

Ratio of Volume Average Particle Diameter of Particles and Thickness of Portion of Image Receiving Layer where the Particles do not Exist:

In the exemplary embodiment of the present invention, the volume average particle diameter of the particles contained in the image receiving layer is larger than the thickness of the portion of the image receiving layer where the particles do not exist. If the volume average particle diameter of the particles is not larger than the foregoing thickness of the image receiving layer, the generation of blister is not suppressed, and a coefficient of friction of the image receiving layer may not be favorably decreased.

Furthermore, the volume average particle diameter of the particles is preferably from 1.5 times to 3 times, more preferably from 1.5 times to 2.8 times, and still more preferably from 1.8 times to 2.5 times relative to the average thickness of the portion of the image receiving layer where the particles do not exist. When the volume average particle diameter of the particles is 1.5 times or more, the generation of blister is more likely suppressed, and the coefficient of friction of the image receiving layer is more favorably decreased. When it is 3.0 times or less, conveyance (paper feed) of the image forming sheet in an image forming apparatus is more smoothly conducted. This means that the diameter of the particles does not become excessive relative to the image receiving layer, and as a result, the matter that the particles are apt to be separated is suppressed; and that conveyance failure to be caused due to attachment of the separated particles to a conveying member, such as a conveyance roller, is suppressed.

Here, the volume average particle diameter of the particles is measured according to the following method.

The volume average particle diameter is a value determined by measuring 1,000 small spheres using an image treatment apparatus by an optical microscope and applying a measured value thereof to the following formula (1).

Volume average particle diameter [μm]=Σ(di⁴·ni)/Σ(di³·ni) (1)

In the formula (1), di is a particle diameter (μm) of a small sphere having an i-th size; and ni is a number of spheres having a particle diameter di.

An average thickness (average film thickness) of each of the layers inclusive of the image receiving layer is measured according to the following method. A film thickness numerical value of each layer is one measured by a digimatic indicator, ID-H053, manufactured by Mitutoyo Corporation.

However, the thickness or average thickness of the image receiving layer as referred to in this specification refers to a thickness or average thickness of the portion of the image receiving layer where the above-described particles do not exist.

Containing of Pigment Having Pores:

In the exemplary embodiment of the present invention, it is preferred that the above-described pigment contains at least one pigment selected from the group consisting of anhydrous kaolin, silica, zeolite, and alumina, namely a pigment having pores (fine pores) in a structure thereof. The above-described pigment, such as anhydrous kaolin, silica, zeolite, and alumina, has pores in a structure thereof and is excellent in absorption properties, and therefore, the pigment is easy to hold a toner to be given to the surface of the image receiving layer and is excellent in holding properties of a toner image.

In addition, in the electrophotographic system, when it is intended to fix the toner image on the surface of the image receiving layer, there may be the case where a fixing member, such as a fixing roll, is brought into contact with the image forming sheet, and a lubricating oil is given to the surface of this fixing member and used from the viewpoint of release properties from the image forming sheet. In the case of an embodiment of giving a lubricating oil to this fixing member, if the image receiving layer contains, as the pigment, the pore-containing pigment as enumerated above, the image receiving layer is apt to absorb even the lubricating oil because of its absorption properties. As a result, there is a concern that wrapping of the image forming sheet around the fixing member is more easily generated.

On the other hand, so long as the image forming sheet according to the exemplary embodiment of the present invention is concerned, in view of the fact that the image receiving layer contains the above-described particles, the contact with the fixing member is point contact, and the coefficient of friction is lowered. Therefore, even in the case of using, as the pigment, those described above, the wrapping around the fixing member may be more likely suppressed.

Containing of an Organic Particle:

In the exemplary embodiment of the present invention, it is preferred that the above-described particles contain an organic particle. As the organic particle, an organic resin particle described hereinafter can be exemplified. The organic particles are generally lower in density than inorganic particles, and therefore, it may be contemplated to reduce the weight of the image receiving layer. In view of more light weight, it is easy to maintain the nerve (force for keeping an original state without being easily folded), and as a result, more excellent running properties are revealed.

Next, the respective layers constituting the image forming sheet of the exemplary embodiment of the present invention are described in detail.

A layer constitution of the image forming sheet of the exemplary embodiment of the present invention is not particularly limited so long as it has at least an image receiving layer and a substrate. An adhesive layer may be provided between the image receiving layer and the substrate.

The layer constitution of the image forming sheet of the exemplary embodiment of the present invention is hereunder described with reference to the accompanying drawings. However, it should not be construed that the constitution of the image forming sheet of the exemplary embodiment of the present invention is limited to the constitutions illustrated below.

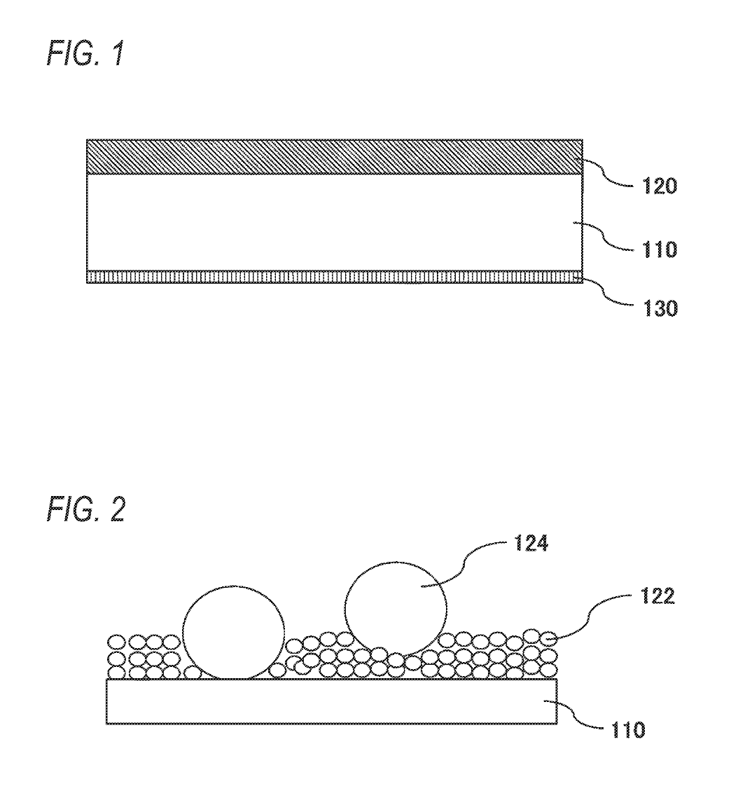

FIG. 1 is a diagrammatic cross-sectional view showing an example of the image forming sheet of the exemplary embodiment of the present invention. The image forming sheet of the exemplary embodiment of the present invention as shown in FIG. 1 is constituted of a substrate 110, an image receiving layer 120, and a back layer 130. Here, an enlarged view of the portion of the image receiving layer 120 of the image forming sheet shown in FIG. 1 is shown in FIG. 2. The image receiving layer 120 has pigments 122 coated on the substrate 110 and particles 124 interspersed among the pigments 122, and further has a binding resin (not illustrated) that binds the pigments 122 and the particles 124 to the substrate 110.

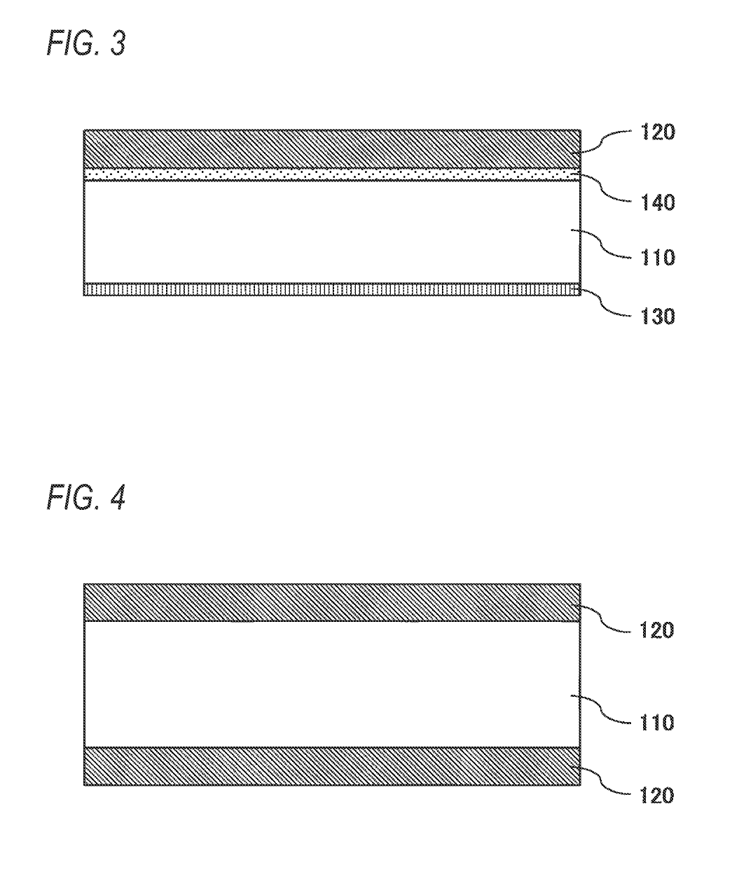

A diagrammatic cross-sectional view of a constitutional example of another image forming sheet of the exemplary embodiment of the present invention is shown in FIG. 3. The image forming sheet of the exemplary embodiment of the present invention as shown in FIG. 3 has a constitution in which an adhesive layer 140 is provided between the substrate 110 and the image receiving layer 120.

A diagrammatic cross-sectional view of a constitutional example of still another image forming sheet of the exemplary embodiment of the present invention is shown in FIG. 4. The image forming sheet of the exemplary embodiment of the present invention as shown in FIG. 4 has a constitution in which the image receiving layer 120 is provided on the both sides of the substrate 110.

### (Substrate)

Next, the substrate which is used in the exemplary embodiment of the present invention is described.

As the substrate, for example, resin sheets are exemplified, and plastic films are representatively used. Above all, polyethylene terephthalate (PET) films are preferred from the viewpoints of costs as well as mechanical properties and processability for industrial use. Incidentally, the PET film refers to a film containing polyethylene terephthalate as a main component, and a content of this main component is preferably 80% by mass or more, and more preferably 90% by mass or more.

Other examples include polyacetate films, cellulose triacetate films, nylon films, polyethylene naphthalate films, polycarbonate films, polysulfone films, polystyrene films, polyphenylene sulfide films, polyphenylene ether films, cycloolefin films, polypropylene films, cellophane, and ABS (acrylonitrile-butadiene-styrene) resin films. Furthermore, such a material may be colored upon mixing with a pigment.

Although a production method of the substrate which is used in the exemplary embodiment of the present invention is arbitrary, it is fabricated utilizing a known method, such as a coextrusion method and a lamination method.

Incidentally, as a general fabrication method, there is exemplified a method in which after being coextruded, the resulting film is allowed to come into a longitudinal stretching process and then stretched between two or more rolls having a different tangential speed from each other to control to a desired film thickness, followed by winding up. In the base of biaxial stretching, the film having passed through the above-described processes is introduced directly into a tenter and stretched from 2.5 times to 5 times in the width direction. At this time, a desired stretching temperature is in the range of from 100° C. to 200° C.

The biaxially stretched film thus obtained may be subjected to a heat treatment. It is desired to conduct the heat treatment within the tenter. In particular, if the film is subjected to a heat treatment while relaxing lengthwise and breadthwise, a film with low thermal shrinkage is obtained. The biaxially stretched film is especially desired as the substrate.

### (Image Receiving Layer)

Binding Resin:

Examples of the binding resin which is contained in the image receiving layer include thermoplastic resins, such as polyethylene, polypropylene, polystyrene, polycarbonate, and polyesters; and thermosetting resins or UV curable resins, such as phenol resins, urea resins, unsaturated polyesters, epoxy resins, and silicon resins. Furthermore, vinyl chloride-based resins (for example, vinyl chloride-based emulsions) and the like are also useful.

In (preliminary) drying at the time of forming (coating) on the substrate, the image receiving layer is desirably provided with a holding force (aggregation force) to such extent that winding processing of the sheet may be conducted and properties such that it does not adhere to the back side of the sheet to be grounded. For that reason, as for the resin which is contained in the image receiving layer, after coating, its surface does not reveal stickiness in terms of finger touch at a temperature preferably in the range of from about normal temperature (22° C.) to about 40° C. (namely corresponding to the winding and storage temperature), and it is desired to use a resin satisfying this requirement.

Although a content of the binding resin in the image receiving layer is not particularly limited, it is preferably from 3% by mass to 40% by mass, more preferably from 5% by mass to 25% by mass, and still more preferably from 10% by mass to 20% by mass.

Pigment:

Examples of the pigment which is contained in the image receiving layer include anhydrous kaolin, silica, zeolite, and alumina.

A pigment having pores (fine pores) in a structure thereof is preferred, and specifically, at least one pigment selected form the group consisting of anhydrous kaolin, silica, zeolite, and alumina is preferred.

Although a volume average particle diameter of the pigment is not particularly limited, it is preferably from 0.2 μm to 3.0 μm, more preferably from 0.3 μm to 2.4 μm, and still more preferably from 0.5 μm to 2.0 μm.

Although a content of the pigment in the image receiving layer is not particularly limited, it is preferably from 70% by mass to 95% by mass, more preferably from 75% by mass to 95% by mass, still more preferably from 80% by mass to 95% by mass, and yet still more preferably from 85% by mass to 90% by mass.

Particles:

In the exemplary embodiment of the present invention, particles are contained in the image receiving layer, and a volume average particle diameter of the particles is larger than a thickness of a portion of the image receiving layer where the particles do not exist. The particles are interspersed among the pigment coated on the substrate in the image receiving layer.

The volume average particle diameter of the particles is preferably from 1.5 times to 3 times, more preferably from 1.5 times to 2.8 times, and still more preferably from 1.8 times to 2.5 times relative to the average thickness of the portion of the image receiving layer where the particles do not exist.

Examples of a shape of the particles include a spherical shape, a tabular shape, an acicular shape, and an amorphous shape. Spherical particles are more preferred from the viewpoint of decreasing the coefficient of friction. Those having a tabular shape, an acicular shape, or an amorphous shape may also be used so long as the performances are not impaired.

Although a volume average particle diameter of the particles is not particularly limited, it is preferably from 6 μm to 30 μm, more preferably from 10 μm to 25 μm, and still more preferably 15 μm to 20 μm.

Although a content of the particles in the image receiving layer is not particularly limited, it is preferably from 4% by mass to 50% by mass, more preferably from 5% by mass to 50% by mass, still more preferably from 10% by mass to 30% by mass, and yet still more preferably from 12% by mass to 20% by mass.

A mass ratio of the particles and the pigment-containing resin component (binding resin) ((particle)/(pigment+binding resin)) is preferably in the range of from 5/95 to 30/70, and more preferably in the range of from 10/90 to 20/80. In the case where the proportion of the particles falls within the foregoing range, favorable image qualities are kept within tolerable ranges regarding disturbance of the image on the image forming sheet and a lowering of the image density. When the mass ratio is the foregoing lower limit value or more, the coefficient of friction between the sheets as the image forming sheet does not become excessive high, jam or multi feed within an electrophotographic apparatus is suppressed at the time of image formation, and the productivity is kept. When the mass ratio is the foregoing upper limit or less, an amount of protrusion of particles that are larger than the layer of the toner image does not relatively increase in excess, a lowering of the density on the image surface is suppressed, and light scattering in a protruded portion does not become excessively large, so that the image qualities are kept.

As for the particles which are used in the exemplary embodiment of the present invention, in the case where the particles are constituted of an organic resin particle, specifically, acrylic crosslinking type particles made of methyl acrylate, ethyl acrylate, butyl acrylate, dodecyl acrylate, octyl acrylate, phenyl acrylate, methyl methacrylate, ethyl methacrylate, butyl methacrylate, dodecyl methacrylate, or the like are preferred. In addition to these, homopolymers or copolymers obtained by polymerizing at least one member of styrenes, such as styrene, vinylstyrene, and chlorostyrene; monoolefins, such as ethylene, propylene, butylene, and isobutylene; vinyl esters, such as vinyl acetate, vinyl propionate, vinyl benzoate, and vinyl butyrate; esters of α-unsaturated fatty acid monocarboxylic acids; vinyl ethers, such as vinyl methyl ether, vinyl ethyl ether, and vinyl butyl ether; vinyl ketones, such as vinyl methyl ketone, vinyl hexyl ketone, and vinyl isopropenyl ketone; or diene-based monomers, such as isoprene and 2-chlorobutadiene may be mixed.

The particles may be mixed with an inorganic particle. Specific examples thereof include mica, talc, silica, calcium carbonate, zinc oxide, halloysite clay, kaolin, hydrochloric acid magnesium carbonate, quartz powder, titanium dioxide, barium sulfate, calcium sulfate, and alumina.

Release Agent:

Furthermore, the image receiving layer may contain a release agent, such as natural or synthetic waxes, release resins, reactive silicone compounds, and modified silicone oils.

Specifically, examples of the wax include natural waxes, such as carnauba wax, beeswax, montan wax, paraffin wax, and microcrystalline wax; and synthetic waxes, such as low-molecular weight polyethylene wax, low-molecular weight oxidized polyethylene wax, low-molecular weight polypropylene wax, low-molecular weight oxidized polypropylene wax, higher fatty acid wax, higher fatty acid ester wax, and sasol wax. These waxes may be used solely or as a mixture of plural members thereof.

A film thickness of the image receiving layer 120 is desirably in the range of from 4 μm to 20 μm, more desirably in the range of from 5 μm to 15 μm, and still more desirably in the range of from 8 μm to 12 μm.

### (Adhesive Layer)

As shown in FIG. 3, for the purpose of strengthening the adhesiveness between the image receiving layer and the substrate, the adhesive layer 140 may be provided between the image receiving layer 120 and the substrate 110.

Although a film thickness of the adhesive layer 140 is not particularly limited, it is desirably in the range of from 0.1 μm to 10 μm, and more desirably in the range of from 1 μm to 5 μm.

### (Back Layer)

In the image forming sheet according to the exemplary embodiment of the present invention, as shown in FIG. 1, the back layer 130 may be further provided on the outside of the substrate 110 (opposite side to the side on which the image receiving layer 120 is provided) from the viewpoint of giving the nerve and also the viewpoint of controlling the resistance, and so forth.

Taking into consideration the material costs, a film thickness of the back layer 130 is desired to be thin, and it is desirably from 0.3 μm to 1 μm.

### (Physical Properties of Image Forming Sheet)

In the image forming sheet in the exemplary embodiment of the present invention, a difference in surface resistivity between the front and back sides at 23° C. and 55% RH is desirably within four digits, and more desirably within three digits.

Incidentally, the surface resistivity is measured according to JIS K6911 by using a circular electrode (for example, HIGHRESTER IP “HR Probe”, manufactured by Mitsubishi Petrochemical Co., Ltd.) in an environment at 23° C. and 55% RH.

### (Production Method of Image Forming Sheet)

Here, a production method of the image forming sheet is described while exemplifying the image forming sheet according to the exemplary embodiment of the present invention as shown in FIG. 1. The image forming sheet of the exemplary embodiment of the present invention as shown in FIG. 1 is constituted of the substrate 110, the image receiving layer 120, and the back layer 130.

As for another constitution of the image forming sheet according to the exemplary embodiment of the present invention, for example, the adhesive layer 140 may be disposed as shown in FIG. 3. In this case, the image forming sheet may be formed by coating a material serving as the adhesive layer 140 on the surface of the substrate 110 and then coating a coating layer serving as the image receiving layer 120 thereon.

The coating layer of the image receiving layer 120 is formed by mixing the respective components inclusive of the resin, the pigment, the particles, and besides, a wax and the like by using an organic solvent or water, or the like, dispersing the mixture with ultrasonic waves or by using an apparatus, such as a wave rotor, an attritor, and a sand mill, to fabricate a coating liquid, and coating the coating liquid directly on the surface of the substrate 110 or the surface of the adhesive layer 140.

As for the coating method, commonly used methods, such as a blade coating method, a wire bar coating method, a spray coating method, an immersion coating method, a bead coating method, an air knife coating method, a curtain coating method, and a roll coating method, are adopted.

For example, in the case where the image forming sheet has the coating layer on the both sides of the substrate 110, the coating may be first applied on either side of the substrate 110, or may be simultaneously applied on the both sides of the substrate 110.

The drying at the time of forming the coating layer on the surface of the substrate 110 may adopt air drying, but heat drying is an easy way to dry. The drying method may be a commonly used method, such as an in-oven drying method, a conveyor oven drying method, and a heated-roller drying method.

From the standpoint of actual use, a coefficient of static friction on the surface of the image forming sheet is desirably 0.8 or less, and more desirably 0.7 or less. A coefficient of kinetic friction on the surface of the image forming sheet is desirably in the range of from 0.05 to 1, and more preferably in the range of from 0.1 to 0.65.

In the exemplary embodiment of the present invention, for example, a toner image is formed as an image on the surface of the image forming sheet. In the case of forming a toner image, it is desired that fixing of the formed toner image is conducted such that a temperature of the surface (image-formed side) of the image forming sheet is equal to or lower than a melting temperature of the toner. Taking into consideration the melting temperature of a typical toner, the fixing is conducted such that the surface temperature of the image forming sheet is desirably 130° C. or lower, and more desirably 110° C. or lower.

To form an image on the image forming sheet by the electrophotographic system, the formation of an electric charge is caused on the surface of a visual receptor (i.e., image carrier) for electrophotography, and the image information thus obtained on the surface of the visual receptor is then subjected to exposure to form an electrostatic latent image corresponding to the exposure. Subsequently, a toner that is an image forming material is supplied from a developing machine to the electrostatic latent image on the surface of the visual receptor to visualize the electrostatic latent image with the toner (thereby forming a toner image). Furthermore, the toner image thus formed is transferred onto the side of the image forming sheet on which the image receiving layer is formed. Finally, the transferred toner image is fixed on the surface of the image receiving layer by heat, pressure, or the like, and the image forming sheet is then discharged from the electrophotographic apparatus.

### EXAMPLES

The present invention is hereunder more specifically described by reference to Examples, but it should not be construed that the present invention is limited thereto. The terms “part” and “%” in the following Examples and Comparative Examples mean “part by mass” and “mass %”, respectively.

### Example 1

An image forming sheet A1 for electrophotography is fabricated in the following way. A fabrication method thereof is hereunder described for every fabrication process.

### Preparation of Image Receiving Layer Coating Liquid a

To 55 parts of a vinyl chloride-acrylic copolymer-based resin (VINYBLAN 700, manufactured by Nissin Chemical Co., Ltd., solid concentration: 30%) as a binder resin, 200 parts of pure water, 150 parts (resin/pigment=10/90) of a calcined clay (GLOMAX LL, manufactured by Takehara Chemical Kogyo Co., Ltd.) as a pigment, and 8.3 parts of spherical particles of crosslinked polybutyl methacrylate (BM30X-8, manufactured by Sekisui Plastics Co., Ltd., volume average particle diameter: 8 μm) as particles are added and thoroughly mixed and stirred, thereby preparing an image receiving layer coating liquid a.

### Fabrication of Image Forming Sheet A1

The image receiving layer coating liquid a is coated on the front and back sides of a biaxially stretched PET film (LUMIRROR X21, manufactured by Toray Industries, Inc., thickness: 100 μm) as a substrate by using a bar coater and then dried at 100° C. for one minute, thereby forming an image receiving layer having a film thickness of 5 μm on both of the front and back sides of the substrate. Thereafter, the resultant is cut in an A4 size (210 mm×297 mm) to fabricate 200 sheets of an image forming sheet A1.

### (Evaluation of Image Forming Sheet)

### —Measurement of Coefficient of Static Friction—

A coefficient of static friction is measured in the following manner in conformity with the horizontal method of JIS-P8147 (revised: 2010) (7). In the test environment under a condition at room temperature (22° C.) and a humidity of 55%, 20 sheets of the image forming sheet A1 are laminated; a thread having a weak adhesive tape installed therein and having a width of 63 mm, a length of 76 mm, and a weight of 240 g is placed on the sheet of the uppermost part; the sheet of the uppermost part is moved in the lateral direction at a moving speed of 150 mm/min; and the coefficient of static friction of ten sheets is continuously measured.

### —Evaluation of Conveyability in Electrophotographic Apparatus—

100 sheets of the image forming sheet A1 are set in a tray of an electrophotographic apparatus (DocuColor 1450GA, manufactured by Fuji Xerox Co., Ltd.), and a color image including the holder's photograph and name, letters and numbers having a size of from 1 point to 5 points, and a solid image is printed on the side of the image receiving layer continuously for the 100 sheets, thereby confirming whether or not a stop of conveyance (jam) to be caused due to the sheet in the apparatus, or multi feed in which a plurality of the sheets are accidentally conveyed at one time, is generated. The case where the jam or multi feed is generate even one time is evaluated as “B”; and the case where the jam or multi feed is not generated is evaluated “A”.

### —Evaluation of Image Quality—

With respect to the quality of the image formed on the image forming sheet A1, a degree of generation of an image defect (e.g., image collapse and image deletion) is evaluated through visual inspection. The case where the generation of an image defect is not confirmed is evaluated as “A”; and the case where even a little image defect is observed is evaluated as “B”.

### —Evaluation of Blister—

With respect to the image formed on the image forming sheet A1, the presence or absence of the generation of an image defect (roughness on the solid image surface) which is considered to be caused due to a phenomenon (blister) in which air contained in the toner image is swollen at the time of fixing is evaluated. The case where the generation of an image defect (roughness on the solid image surface) is not confirmed is evaluated as “A”; the case where even a little image defect (roughness on the solid image surface) is observed is evaluated as “B”; and the case where an extremely lot of image defects are observed is evaluated as “C”.

The thus obtained evaluation results of the tests are shown in Tables 1 and 2.

### Example 2

### Preparation of Image Receiving Layer Coating Liquid b

To 110 parts of a vinyl chloride-acrylic copolymer-based resin (VINYBLAN 701, manufactured by Nissin Chemical Co., Ltd., solid concentration: 30%) as a binder resin, 170 parts of pure water, 132 parts (resin/pigment=20/80) of a calcined clay (SATINTONE W, manufactured by Takehara Chemical Kogyo Co., Ltd.) as a pigment, and 16.5 parts of spherical particles of crosslinked polymethyl acrylate (MX-2000, manufactured by Soken Chemical and Engineering Co., Ltd., volume average particle diameter: 20 μm) as particles are added and thoroughly mixed and stirred, thereby preparing an image receiving layer coating liquid b.

### Fabrication of Image Forming Sheet A2

In Example 1, the image receiving layer coating liquid b is used in place of the image receiving layer coating liquid a, the image receiving layer coating liquid b is coated on the front and back sides of a biaxially stretched PET (polyethylene terephthalate) film (LUMIRROR T-60, manufactured by Toray Industries, Inc., thickness: 100 μm) as a substrate by using a bar coater and then dried at 100° C. for one minute, thereby forming an image receiving layer having a film thickness of 10 μm. Thereafter, the resultant is cut in an A4 size (210 mm×297 mm) to fabricate 200 sheets of an image forming sheet A1. Then, the same evaluations as those in Example 1 are conducted.

The results are shown in Table 1.

### Example 3

### Preparation of Image Receiving Layer Coating Liquid c

To 150 parts of a vinyl chloride-acrylic copolymer-based resin (VINYBLAN 702, manufactured by Nissin Chemical Co., Ltd., solid concentration: 30%) as a binder resin, 120 parts of pure water, 150 parts (resin/pigment=30/70) of a calcined clay (SATINTONE PLUS, manufactured by Takehara Chemical Kogyo Co., Ltd.) as a pigment, and 18.5 parts of generally spherical particles of alumina (AO-509, manufactured by Admatechs Company Limited, volume average particle diameter: 12 μn) as particles are added and thoroughly mixed and stirred, thereby preparing an image receiving layer coating liquid c.

### Fabrication of Image Forming Sheet A3

An image forming sheet A3 is fabricated in the same manner as that in Example 2, except that in Example 2, the image receiving layer coating liquid c is used in place of the image receiving layer coating liquid b, thereby forming an image receiving layer having an image receiving layer film thickness of 8 μm. Then, the same evaluations as those in Example 1 are conducted.

The results are shown in Table 1.

### Example 4

### Preparation of Image Receiving Layer Coating Liquid d

To 55 parts of a vinyl chloride-vinyl acetate copolymer-based resin (VINYBLAN 603, manufactured by Nissin Chemical Co., Ltd., solid concentration: 49.3%) as a binder resin, 395 parts of pure water, 245 parts (resin/pigment=10/90) of a calcined clay (OPACILITE, manufactured by Imerys Minerals Japan K.K.) as a pigment, and 40.7 parts of spherical particles of crosslinked polymethyl acrylate (MX-3000, manufactured by Soken Chemical and Engineering Co., Ltd., volume average particle diameter: 30 μm) are added and thoroughly mixed and stirred, thereby preparing an image receiving layer coating liquid d.

### Fabrication of Image Forming Sheet A4

An image forming sheet A4 is fabricated in the same manner as that in Example 2, except that in Example 2, the image receiving layer coating liquid d is used in place of the image receiving layer coating liquid b, thereby forming an image receiving layer having an image receiving layer film thickness of 10 μm. Then, the same evaluations as those in Example 1 are conducted.

The results are shown in Table 1.

### Example 5

### Preparation of Image Receiving Layer Coating Liquid e

To 100 parts of a vinyl chloride-acrylic copolymer-based resin (VINYBLAN 700, manufactured by Nissin Chemical Co., Ltd., solid concentration: 30%) as a binder resin, 140 parts of pure water, 136 parts of a calcined clay (GLOMAX LL, manufactured by Takehara Chemical Kogyo Co., Ltd.) and 34 parts of calcium carbonate (resin/pigment=15/85) as a pigment, and 40 parts of spherical particles of crosslinked polymethyl acrylate (MX-3000, manufactured by Soken Chemical and Engineering Co., Ltd., volume average particle diameter: 30 μm) are added and thoroughly mixed and stirred, thereby preparing an image receiving layer coating liquid e.

### Fabrication of Image Forming Sheet A5

An image forming sheet A5 is fabricated in the same manner as that in Example 1, except that in Example 1, the image receiving layer coating liquid e is used in place of the image receiving layer coating liquid a, thereby forming an image receiving layer having an image receiving layer film thickness of 20 μm. Then, the same evaluations as those in Example 1 are conducted.

The results are shown in Table 1.

### Example 6

### Preparation of Image Receiving Layer Coating Liquid f

To 55 parts of a vinyl chloride-acrylic copolymer-based resin (VINYBLAN 700, manufactured by Nissin Chemical Co., Ltd., solid concentration: 30%) as a binder resin, 395 parts of pure water, 245 parts (resin/piguient=10/90) of silica (NIPSIL HD-2, manufactured by Tosoh Silica Corporation) as a pigment, and 55 parts of spherical particles of crosslinked polybutyl methacrylate (BM30X-8, manufactured by Sekisui Plastics Co., Ltd., volume average particle diameter: 8 μm) are added and thoroughly mixed and stirred, thereby preparing an image receiving layer coating liquid f.

### Fabrication of Image Forming Sheet A6

An image forming sheet A6 is fabricated in the same manner as that in Example 1, except that in Example 1, the image receiving layer coating liquid f is used in place of the image receiving layer coating liquid a, thereby forming an image receiving layer having an image receiving layer film thickness of 5 μm. Then, the same evaluations as those in Example 1 are conducted.

The results are shown in Table 1.

### Example 7

### Preparation of Image Receiving Layer Coating Liquid g

To 55 parts of a vinyl chloride-vinyl acetate copolymer-based resin (VINYBLAN 603, manufactured by Nissin Chemical Co., Ltd., solid concentration: 49.3%) as a binder resin, 395 parts of pure water, 245 parts (resin/pigment=15/85) of zeolite (SP#2300, manufactured by Nitto Funka Kogyo K.K.) as a pigment, and 40 parts of spherical particles of crosslinked polymethyl acrylate (SSX-115, manufactured by Sekisui Plastics Co., Ltd., volume average particle diameter: 15 μm) are added and thoroughly mixed and stirred, thereby preparing an image receiving layer coating liquid g.

### Fabrication of Image Forming Sheet A7

An image forming sheet A7 is fabricated in the same manner as that in Example 1, except that in Example 1, an image receiving layer having an image receiving layer film thickness of 10 μm is formed on the front and back surfaces of a biaxially stretched PET film (LUMIRROR E20, manufactured by Toray Industries, Inc., thickness: 100 μm) as a substrate by using the image receiving layer coating liquid g. Then, the same evaluations as those in Example 1 are conducted.

The results are shown in Table 1.

### Example 8

### Fabrication of Image Forming Sheet A8

An image forming sheet A8 is fabricated in the same manner as that in Example 4, except that in Example 4, the film thickness of the image receiving layer to be formed is changed to 8 μm. Then, the same evaluations as those in Example 1 are conducted.

However, in this Example, in the evaluation of conveyability, paper feed failure in the paper feed section is generated three times. The results are shown in Table 1.

### Comparative Example 1

### Fabrication of Image Forming Sheet B1

An image forming sheet B1 is fabricated in the same manner as that in Example 1, except that with respect to the image receiving layer coating liquid a fabricated in Example 1, a particle-free image receiving layer coating liquid a′ is fabricated, and subsequently, in Example 1, the image receiving layer coating liquid a′ is used in place of the image receiving layer coating liquid a. Then, the same evaluations as those in Example 1 are conducted.

In the evaluation of conveyability, the jam is generated one time, and the multi feed is generated five times. The results are shown in Table 2.

### Comparative Example 2

### Fabrication of Image Forming Sheet B2

An image forming sheet B2 is fabricated in the same manner as that in Example 2, except that with respect to the image receiving layer coating liquid b fabricated in Example 2, a particle-free image receiving layer coating liquid b′ is fabricated, and subsequently, in Example 2, the image receiving layer coating liquid b′ is used in place of the image receiving layer coating liquid b. Then, the same evaluations as those in Example 1 are conducted.

In the evaluation of conveyability, the jam is generated one time, and the multi feed is generated ten times. The results are shown in Table 2.

### Comparative Example 3

### Fabrication of Image Forming Sheet B3

An image forming sheet B3 is fabricated in the same manner as that in Example 3, except that with respect to the image receiving layer coating liquid c fabricated in Example 3, a particle-free image receiving layer coating liquid c′ is fabricated, and subsequently, in Example 3, the image receiving layer coating liquid c′ is used in place of the image receiving layer coating liquid c. Then, the same evaluations as those in Example 1 are conducted.

In the evaluation of conveyability, the jam is generated two times, and the multi feed is generated eight times. The results are shown in Table 2.

### Comparative Example 4

### Fabrication of Image Forming Sheet B4

An image forming sheet B4 is fabricated in the same manner as that in Example 4, except that with respect to the image receiving layer coating liquid d fabricated in Example 4, a particle-free image receiving layer coating liquid d′ is fabricated, and subsequently, in Example 4, the image receiving layer coating liquid d′ is used in place of the image receiving layer coating liquid d. Then, the same evaluations as those in Example 1 are conducted.

In the evaluation of conveyability, the multi feed is generated eleven times. The results are shown in Table 2.

### Comparative Example 5

### Fabrication of Image Forming Sheet B5

An image forming sheet B5 is fabricated in the same manner as that in Example 1, except that in Example 1, the film thickness of the image receiving layer to be formed is changed to 8 μm. Then, the same evaluations as those in Example 1 are conducted.

In the evaluation of conveyability, the jam is generated one time, and the multi feed is generated seven times. The results are shown in Table 2.

Incidentally, in the image forming sheet according to the exemplary embodiment of the present invention, the image receiving layer contains, in addition to the pigment and the binder resin, the particles having a volume average particle diameter larger than a thickness of the portion of the image receiving layer where the particles do not exist. For that reason, it may be considered that the image receiving layer contains the particles of a large particle diameter, whose particle diameter falls within the foregoing range, and the pigment having a relatively smaller particle diameter than that of the particles, and a space is formed between the pigment and the particles. A vent hole through which air comes out, namely an escape space of air is formed in the image receiving layer due to this space, and air in the toner image also comes out from this space.

In the image forming sheet according to the exemplary embodiment of the present invention, the particles having a larger volume average particle diameter than the thickness of the portion of the image receiving layer where the particles do not exist are contained in the image receiving layer. The particles are larger than the thickness of the image receiving layer, and therefore, the particles are exposed from the surface of the image receiving layer. For that reason, the contact with the surface of the image receiving layer becomes point contact, and the contact area becomes smaller. As a result, the coefficient of friction is decreased.

As described above, in view of the fact that the contact area with the surface of the image receiving layer is decreased, for example, at the time of winding up the sheet in a roll state, or in the case of superimposing a plurality of the sheets, the coefficient of friction between the sheets is decreased. As a result, the running properties in the image forming apparatus are enhanced.

When it is intended to fix the toner image formed on the surface of the image receiving layer, the toner image is fixed while pressurizing the sheet by a fixing member, such as a fixing roll, and therefore, there may be the case where the image receiving layer side of the sheet is wrapped around the fixing member. On the other hand, in the exemplary embodiment of the present invention, as described above, the contact area of the image receiving layer is decreased, and the coefficient of friction is decreased, and therefore, wrapping around the fixing member is also suppressed.

Furthermore, the particles are exposed from the surface of the image receiving layer, and this exposed portion comes into contact with other members. Therefore, an opportunity of the pigment contained in the image receiving layer to contact with other members is decreased, and as a result, peeling-off of the pigment is suppressed, too.

TABLE 1

| | Example 1 | Example 2 | Example 3 | Example 4 |
|---|---|---|---|---|
| | Biaxially stretched PET film | | | |
| Substrate | LUMIRROR X21 | LUMIRROR T-60 | LUMIRROR T-60 | LUMIRROR T-60 |
| | Thickness: 100 μm | Thickness: 100 μm | Thickness: 100 μm | Thickness: 100 μm |

Image receiving layer

| Binding resin | Vinyl chloride-acrylic copolymer-based resin | | | Vinyl |
|---|---|---|---|---|
| | | | | chloride-vinyl |
| | | | | acetate |
| | | | | copolymer-based |
| | | | | resin |
| | VINYBLAN 700 | VINYBLAN 701 | VINYBLAN 702 | VINYBLAN 603 |
| Pigment | Calcined clay | | | |
| | GLOMAX LL | SATINTONE W | SATINTONE | OPACILITE |
| | | | PLUS | |
| Binding resin/pigment | 10/90 | 20/80 | 30/70 | 10/90 |
| ratio | | | | |
| Particle | Crosslinked | Crosslinked | Generally | Crosslinked |
| | polybutyl | polymethyl | spherical particles | polymethyl |
| | methacrylate | acrylate | of alumina | acrylate |
| | BM30X-8 | MX-2000 | AO-509 | MX-3000 |
| Particle diameter of | 8 μm | 20 μm | 12 μm | 30 μm |
| particle | | | | |
| Image receiving layer | 5 μm | 10 μm | 8 μm | 10 μm |
| film thickness | | | | |
| Particle diameter/film | 1.60 | 2.00 | 1.50 | 3.00 |
| thickness ratio | | | | |

Evaluation

| Coefficient of static | 0.65 | 0.60 | 0.70 | 0.50 |
|---|---|---|---|---|
| friction | | | | |
| Conveyability | A | A | A | A |
| Image quality | A | A | A | A |
| Blister | A | A | A | A |
| | Example 5 | Example 6 | Example 7 | Example 8 |
| | Biaxially stretched PET film | | | |
| Substrate | LUMIRROR X21 | LUMIRROR X21 | LUMIRROR E20 | LUMIRROR T-60 |
| | Thickness: 100 μm | Thickness: 100 μm | Thickness: 100 μm | Thickness: 100 μm |

Image receiving layer

| Binding resin | Vinyl chloride-acrylic copolymer-based | | Vinyl chloride-vinyl acetate | |
|---|---|---|---|---|
| | resin | | copolymer-based resin | |
| | VINYBLAN 700 | VINYBLAN 700 | VINYBLAN 603 | VINYBLAN 603 |
| Pigment | Calcined clay | Silica | Zeolite | Calcined clay |
| | GLOMAX | | | |
| | LL/calcium | | | |
| | carbonate (8/2) | | | |
| | | HD-2 | SP#2300 | OPACILITE |
| Binding resin/pigment | 15/85 | 10/90 | 15/85 | 10/90 |
| ratio | | | | |
| Particle | Crosslinked | Crosslinked | Crosslinked | Crosslinked |
| | polymethyl | polybutyl | polymethyl | polymethyl |
| | acrylate | methacrylate | acrylate | acrylate |
| | MX-3000 | BM30X-8 | SSX-115 | MX-3000 |
| Particle diameter of | 30 μm | 8 μm | 15 μm | 30 μm |
| particle | | | | |
| Image receiving layer | 20 μm | 5 μm | 10 μm | 8 μm |
| film thickness | | | | |
| Particle diameter/film | 1.50 | 1.60 | 1.50 | 3.75 |
| thickness ratio | | | | |

Evaluation

| | | | | |
|---|---|---|---|---|
| Coefficient of static | 0.68 | 0.55 | 0.66 | 0.50 |
| friction | | | | |
| Conveyability | A | A | A | B (paper feed |
| | | | | failure) |
| Image quality | A | A | A | A |
| Blister | A | A | A | A |

TABLE 2

| | Comparative | Comparative | Comparative | Comparative | Comparative |
|---|---|---|---|---|---|
| | Example 1 | Example 2 | Example 3 | Example 4 | Example 5 |
| | Biaxially stretched PET film | | | | |
| Substrate | LUMIRROR | LUMIRROR | LUMIRROR | LUMIRROR | LUMIRROR |
| | X21 | T-60 | T-60 | T-60 | X21 |
| | Thickness: | Thickness: | Thickness: | Thickness: | Thickness: |
| | 100 μm | 100 μm | 100 μm | 100 μm | 100 μm |

Image receiving layer

| | | | | Vinyl | |
|---|---|---|---|---|---|
| | | | | chloride- | Vinyl chloride |
| | | | | vinyl acetate | acrylic |
| | | | | copolymer- | copolymer- |
| | Vinyl chloride-acrylic copolymer-based resin | | | based resin | based resin |
| Binding resin | VINYBLAN | VINYBLAN | VINYBLAN | VINYBLAN | VINYBLAN |
| | 700 | 701 | 702 | 603 | 700 |
| | Calcined clay | | | | |
| | GLOMAX | SATINTONE | SATINTONE | | |
| Pigment | LL | W | PLUS | OPACILITE | GLOMAX LL |
| Binding | 10/90 | 20/80 | 30/70 | 10/90 | 10/90 |
| resin/pigment ratio | | | | | |
| Particle | (Nil) | (Nil) | (Nil) | (Nil) | Crosslinked |
| | | | | | polybutyl |
| | | | | | methacrylate |
| | | | | | BM30X-8 |
| Particle diameter of | — | — | — | — | 8 μm |
| particle | | | | | |
| Image receiving layer | 5 μm | 10 μm | 8 μm | 10 μm | 8 μm |
| film thickness | | | | | |
| Particle diameter/film | — | — | — | — | 1.00 |
| thickness ratio | | | | | |

Evaluation

| | | | | | |
|---|---|---|---|---|---|
| Coefficient of static | 1.05 | 1.10 | 1.20 | 0.95 | 1.15 |
| friction | | | | | |
| Conveyability | B (multi | B (multi | B (multi | B (multi | B (multi |
| | feed) | feed) | feed) | feed) | feed) |
| Image quality | A | A | A | A | A |
| Blister | B | C | C | B | B |

What is claimed is:

1. An image forming sheet for electrophotography, comprising:
a substrate; and
an image receiving layer having a pigment coated on the substrate, particles interspersed among the pigment, and a binding resin;
wherein a volume average particle diameter of the particles is larger than a thickness of a portion of the image receiving layer where the particles do not exist.

2. The image forming sheet for electrophotography according to claim 1,
wherein the volume average particle diameter of the particles is from 1.5 times to 3 times relative to the average thickness of the portion of the image receiving layer where the particles do not exist.

3. The image forming sheet for electrophotography according to claim 1,
wherein the pigment contains at least one member selected from the group consisting of anhydrous kaolin, silica, zeolite, and alumina.

4. The image forming sheet for electrophotography according to claim 1,
wherein the particles contain an organic particle.

5. The image forming sheet for electrophotography according to claim 1,
wherein the substrate is a resin sheet.

6. The image forming sheet for electrophotography according to claim 5,
wherein the resin sheet is composed of polyethylene terephthalate as a main component.

7. An image forming sheet for electrophotography, comprising:
a substrate; and
an image receiving layer having a pigment coated on the substrate, particles interspersed among the pigment, and a binding resin;
wherein a volume average particle diameter of the particles is larger than a thickness of a portion of the image receiving layer where the particles do not exist, and
a content of the pigment in the image receiving layer is from 70% by mass to 95% by mass.

8. The image forming sheet for electrophotography according to claim 7,
wherein the volume average particle diameter of the particles is from 1.5 times to 3 times relative to the average thickness of the portion of the image receiving layer where the particles do not exist.

9. The image forming sheet for electrophotography according to claim 7,
wherein the pigment contains at least one member selected from the group consisting of anhydrous kaolin, silica, zeolite, and alumina.

10. The image forming sheet for electrophotography according to claim 7,
wherein the particles contain an organic particle.

11. The image forming sheet for electrophotography according to claim 7,
wherein the substrate is a resin sheet.

12. The image forming sheet for electrophotography according to claim 11,
wherein the resin sheet is composed of polyethylene terephthalate as a main component.
